(19) United States
(12) Patent Application Publication
(10) Pub. No.: US 2024/0046663 A1
(43) Pub. Date: Feb. 8, 2024

(54) METHOD FOR OPERATING A MOTOR VEHICLE WITH AT LEAST ONE ENVIRONMENT DETECTION DEVICE

(71) Applicant: CARIAD SE, Wolfsburg (DE)

(72) Inventors: Christoph WEIGAND, Gaimersheim (DE); Tobias SCHLEICHER, Wettstetten (DE)

(21) Appl. No.: 18/363,591

(22) Filed: Aug. 1, 2023

(30) Foreign Application Priority Data
Aug. 5, 2022 (DE) 102022119772.7

(51) Int. Cl. G06V 20/59; G06V 20/56; B60W 40/08

(52) U.S. Cl. CPC G06V 20/597; G06V 20/56; B60W 40/08; B60W 2540/225; B60W 2540/229

(57) ABSTRACT

The disclosure relates to a method for operating a motor vehicle having at least one environment sensing device that senses an environment of the motor vehicle and to the motor vehicle. The method involves: determining field of vision data that describe a field of vision of a driver of the motor vehicle; determining partial field data that describe a partial field of the environment of the motor vehicle overlapping the field of vision of the driver, by evaluating the field of vision data; and reducing sensing or evaluating of sensing data that are sensed by the at least one environment sensing device and that describe the partial field according to the partial field data.

### BACKGROUND

### Technical Field

The disclosure relates to a method for operating a motor vehicle having at least one environment sensing device that senses an environment of the motor vehicle. The disclosure furthermore relates to a motor vehicle for carrying out such a method.

### Description of the Related Art

A motor vehicle can comprise at least one environment sensing device, which is adapted to sense the environment of the motor vehicle. The environment sensing device can be adapted to sense the environment of the motor vehicle continuously, but then sensing data are provided continuously. This can result in a relatively large volume of sensing data being provided in the motor vehicle. Yet the sensing of such a volume of sensing data and the evaluation thereof is resource-intensive. It may therefore be advisable to reduce the volume of sensing data in the motor vehicle as compared to the volume in the case of a continuous production.

DE 10 2018 220 395 A1 shows a control device for controlling a sensor arrangement in order to monitor a working range of a working machine. Depending on the direction of rotation of a working arm of the working machine, an activated or deactivated state of a monitoring function of the sensor arrangement can be provided with respect to at least one portion of the working range of the working machine.

DE 100 39 795 A1 shows a method for warning the driver of a vehicle, the warning being put out in dependence on the attentiveness of the driver.

### BRIEF SUMMARY

Embodiments of the disclosure provide a solution by way of which the power consumption of an environment sensing device of a motor vehicle and/or the computing power required in the motor vehicle in order to evaluate the sensing data of the environment sensing device can be reduced.

A first aspect of the disclosure relates to a method for operating a motor vehicle having at least one environment sensing device that senses an environment of the motor vehicle. The environment is a region bordering on the motor vehicle and bounded in space by a sensing region of the environment sensing device. The environment sensing device is for example a camera device, comprising for example, a front camera, a side camera and/or a rear camera. Alternatively or additionally, the environment sensing device can be a radar device, a Lidar device, an ultrasound sensor and/or an infrared measurement device. In other words, the environment sensing device is a sensor device which is adapted to detect an outer region of the motor vehicle.

The method involves the determining of field of vision data. The field of vision data describe a field of vision of the driver of the motor vehicle. The field of vision data can be determined, for example, by sensing and evaluating a viewing direction as well as a focus zone of the eyes of the driver. The determining of the field of vision data is preferably based on data sensed by way of the motor vehicle, which are sensed for example by way of an interior sensing device of the motor vehicle. The field of vision is preferably provided in the form of an angle region. Furthermore, the method involves a determination of partial field data by evaluating the field of vision data so determined. The partial field data describe a partial field of the environment of the motor vehicle which overlaps with the field of vision of the driver. The partial field can correspond to the field of vision, that is, the partial field and the field of vision can be an identical region in the environment of the motor vehicle.

The method involves operating the motor vehicle such that a sensing and/or evaluating of sensing data which are sensed by way of the at least one environment sensing device and which describe the partial field according to the partial field data so determined is at least reduced. In other words, the motor vehicle is operated for example in a mode in which less sensing data are detected in the partial field, for example, than would be the case in a normal mode of the motor vehicle. The environment sensing device is appropriately actuated for this. Alternatively or additionally, the environment sensing device can be operated in normal mode, for example, but the evaluation of the sensing data so provided is reduced or simplified, so that the power consumption can be reduced during the evaluating of the sensing data. The normal mode for example is always activated when the method is not being carried out, for example, since such is not desired by the user of the motor vehicle.

The altered operation of the motor vehicle in terms of the sensing and/or the evaluating of the sensing data does not involve the entire environment of the motor vehicle, but rather only the partial field that was determined on the basis of the field of vision data. Hence, there is only a reduced sensing and/or evaluating of data in the field of vision of the driver. This is always useful for example if it is assumed that the driver is manually controlling his field of vision, that is, during a manual operation of the motor vehicle when he responds himself to events such as a moving object in the field of vision. Therefore, a reduced performance on the part of the environment sensing device is possible in the field of vision, so that the sensing of sensing data and/or the evaluating of sensing data can be scaled back for the field of vision and thus for the partial field according to the partial field data which have been determined and therefore an operation is possible to a lesser extent than in the regions of the environment located outside the partial field and thus the field of vision of the driver. Thanks to this reduction in activity and reduction in the evaluation expense of the environment sensing device, energy can be saved in the motor vehicle, the system workload can be reduced, such as that due to an evaluation device of the motor vehicle, and/or the hardware aging process of the evaluation device can be slowed down. The evaluation device can be a control device of the motor vehicle. Moreover, it may be possible in this way to plan for a lower average system workload and a lower average power consumption with smaller hardware components, so that costs can be saved, for example. Thus, in the final analysis, the computing power and the power consumption during permanent operation of the environment sensing device are reduced, since the described reduction is done at least in a partial field of the motor vehicle. By employing the method, therefore, the power consumption of the environment sensing device of the motor vehicle and/or the computing power required in the motor vehicle for the evaluation of the sensing data of the environment sensing device is reduced.

The disclosure also encompasses embodiments which yield additional benefits.

One embodiment calls for the reduction in the sensing to consist in that a scan rate of the environment sensing device is reduced. Thus, it can be provided that, for example instead of a former 20 readings per second, only 10 readings per second are taken by way of the environment sensing device. For example, instead of 20 images taken per second by way of a front camera, only 10 images per second are then taken by way of the front camera, for example. In this way, the amount of sensing data taken by way of the front camera, for example, can be cut in half, so that the computing power and the power consumption of the environment sensing device can be reduced. The scan rate can alternatively be termed the amount of sensing data per interval of time. Any desired reduction of the scan rate is possible, for example, by 5 percent, 10 percent, 20 percent, 25 percent, 30 percent, 40 percent, 50 percent, 60 percent, 70 percent, 75 percent, 80 percent, or especially 90 percent. The scan rate can be reduced by a percentage between the mentioned values.

Alternatively or additionally, the reduction in the sensing may consist in that the environment sensing device is deactivated. For example, it can be provided that any detection of sensing data in the partial field is switched off and for example only the remaining environment of the motor vehicle is sensed. This leads to an especially drastic reduction in the power consumption of the environment sensing device.

Alternatively or additionally, the reduction in the sensing may consist in that, when there are at least two redundant environment sensing devices, one of the at least two environment sensing devices is deactivated. If, for example, both a radar device and an infrared measuring device are provided in order to determine the distance from at least one object in the environment of the motor vehicle, one of these two environment sensing devices can be deactivated for the partial field, so that the environment is only still detected by way of the other environment sensing device. In this way, the amount of sensing data for the partial field can likewise be reduced. Redundant environment sensing devices in this case are environment sensing devices which are adapted to sense at least one common kind or one common type of sensing data. Thus, the sensing of the sensing data can be reduced in an especially diversified and effective manner.

Another embodiment calls for the reduction in the evaluation to consist in that a portion of the sensing data which are evaluated out of the sensing data detected overall by way of the environment sensing device is reduced. Thus, for example, it can be provided that only every second, every third, every fifth, every tenth, or in particular every fiftieth measured value which is detected and provided by way of the environment sensing device will be evaluated. In this way, the overall volume of sensing data to be evaluated will be decreased, so that the computing power required in the motor vehicle for the evaluating of the sensing data of the environment sensing device will be reduced as compared to the normal mode. This will affect only the sensing data associated with the partial field of the environment according to the partial field data. Hence, there is no general reduction of the portion of the sensing data to be evaluated for the overall environment of the motor vehicle, but instead only that for the previously determined partial field. The reduction in the computing power can be achieved especially effectively in this way.

An especially advantageous embodiment calls for the determining of driver condition data describing a condition of the driver. The driver condition data can describe, for example, the information as to whether the driver is tired or alert at present. Moreover, attention data are determined which describe the degree of attentiveness with which the driver is looking at the field of vision. The attention data are determined by applying an attention detection criterion to the driver condition data so determined. The attentiveness detection criterion is an algorithm and/or a set of rules by which the attention data can be computed from the driver condition data. Thus, by carrying out the attentiveness detection criterion, the driver condition data are evaluated such that it can be decided whether or not the driver is attentive at present. If the driver is tired according to the driver condition data, he can be evaluated as inattentive. But if he is alert according to the driver condition data, he can be evaluated as attentive. Moreover, a gradation between “attentive” and “inattentive” is possible, where the degree of attentiveness is determined as an intermediate value between 0 and 1, for example. For example, 0 can be taken for inattentive, and 1 for attentive, or vice versa. Depending on how large the attention data are, the more attentive the driver at the present time in this example.

It is proposed that only if the attention data so determined lie in a given attention value range is the sensing and/or evaluating of the sensing data reduced. Thus, at first a check is done to determine whether the driver is sufficiently attentive at present to reduce the sensing and/or evaluating of the sensing data in the partial field and thus in the field of vision of the driver, or not. The given attention value range in the example given above lies for example between 0.5 and 1. If, for example, it was determined by way of the driver condition data that the driver is tired at present, since for example his blinking frequency is increased as compared to the blinking frequency normal range and thus lies above a blinking frequency limit value defining a tired condition of the driver, the attention data may take on a value not lying in the attention value range. In this case, it will be assumed that the driver is not attentive enough and therefore the reduction of the sensing and/or evaluating of the sensing data in the partial field will not be done in this example. But if it is found that the driver is attentive, attention data will be determined which lie in the given attention value range and hence the described reduction of the sensing and/or evaluating of the sensing data can be done. In this way, one can reliably ensure that the reduction is done only in situations where the field of vision is in fact being actively monitored by the driver.

It can be provided that the environment sensing device or the motor vehicle will be operated in the normal mode when the attention data lie outside the attention value range.

An additional embodiment calls for the driver condition data to describe at least one of the following conditions of the driver: fatigue; distraction due to operating at least one operating device in the motor vehicle; distraction due to the output of at least one output device in the motor vehicle; responsiveness to an object in the field of vision; and/or changing of the field of vision due to at least one change of viewing direction. Fatigue is typically ascertained by way of an interior detection device, such as an interior camera, which detects, for example, the blinking frequency of the eyes of the driver. With the aid of the blinking frequency, it can be ascertained whether the driver for example is keeping his eyes closed and therefore is sleeping, whether he is blinking a lot, which may indicate fatigue, or whether he is in the normal range for an alert condition in terms of the blinking frequency and therefore is to be evaluated as being alert. Moreover, the posture of the head of the driver can have influence on whether the condition of the driver is identified as being tired or not tired. A lowered head may at least suggest fatigue. Moreover, it is possible to check for example measurement data as to the body temperature and/or the pulse rate of the driver. The pulse rate can be determined for example by way of a capacitive sensor in the steering wheel of the motor vehicle. The body temperature can be determined for example by way of an infrared measurement in the interior of the motor vehicle. In general, typical information can be used to at least help in distinguishing an alert and/or healthy driver from a tired or sick or unhealthy driver. In addition of alternatively to the fatigue, the health condition of the driver can be identified and optionally also evaluated such that the attention data lie outside the given attentiveness range in event of an unhealthy or sick condition.

The distraction due to operating and/or output may involve, for example, the user dealing with an operating device in the motor vehicle, such as a touch-sensitive monitor screen, a button, a rotary push switch, and/or a key, for example, in order to control a function of the motor vehicle. The function of the motor vehicle may be, for example, a navigation system, a multimedia device and/or an air conditioning system of the motor vehicle. Due to operating this device, the driver can be considered as being distracted, so that in such situations there should not be any reduction of the sensing and/or evaluating of the sensing data, for example. In the case of distraction due to the output of the output device, it can be understood for example that the driver is making a telephone call and thus a mobile terminal device and/or at least a loudspeaker is situated as the output device in the motor vehicle. Alternatively or additionally, the output can be a multimedia content, such as an audio book and/or a video, which may lead to a distracting of the driver, so that it can be provided that the sensing and/or evaluating of the sensing data should not be reduced in the case of such an output.

The responsiveness to an object in the field of vision can be realized by way of a tracking of glances, for example, by way of the interior sensor device. For example, if it is determined that the driver is tracking a moving object in the environment with his glance, it can be concluded that he is attentive. Corresponding attention data are then calculated, allowing the described reduction to take place. The changing of the field of vision by at least one change of viewing direction can be taken to mean, for example, a glancing over the shoulder or a changing of the view from left to right or vice versa. A changing of the view may suggest that the driver is actively taking part in the traffic situation, which in turn indicates an attentiveness for which the reduction can be done.

Thanks to the described information, the driver condition can be reliably determined and on this basis a score can be assigned to the attentiveness. The different mentioned conditions are weighted and evaluated by way of the attention detection criterion, so that the described operation of the motor vehicle is activated reliably on the whole and only in situations where the driver is in fact sufficiently attentive.

Moreover, one embodiment calls for the degree of reduction of the sensing and/or evaluating of the sensing data to be dependent on the attention data so determined. For example, if it is determined that the driver while being sufficiently attentive still shows at least one sign of inattentiveness, for example, the blinking frequency is increased as compared to the normal condition, then for reasons of safety the scan rate of the environment sensing device and/or the portion of the sensing data being evaluated can be reduced less so than would be the case if, for example, the attention data indicate a fully alert condition of the driver, for example a value of 0.8 instead of 1 for the attention data. Thus, various intermediate levels are provided between the normal mode without reduction of the sensing and/or evaluating of the sensing data and a maximum reduced sensing and/or evaluating of the sensing data. The maximum reduction involves, for example, the total deactivation of the environment sensing device and a maximum small portion of sensing data being evaluated, out of the total sensing data detected for the partial field. This makes possible a fine and exact adaptation of the reduction to the attentiveness of the driver.

According to one embodiment, it is provided that at least the field of vision data are determined by evaluating of camera data of an interior camera of the motor vehicle. The interior detection sensor is thus preferably the interior camera. Moreover, it can be provided that the camera data of the interior camera will be evaluated to determine the fatigue, the responsiveness to an object in the field of vision and/or the changing of the field of vision by at least one change of viewing direction. Moreover, the camera data may help in ascertaining the distraction of the user. In other words, it can be determined by the motor vehicle itself, without the need for information from other and possibly external sensor devices, which partial field in the environment is being monitored by the driver. In this way, the method can be carried out with particularly slight expense.

According to another embodiment, the partial field according to the partial field data so determined is smaller than the field of vision according to the field of vision data so determined. In other words, the partial field is only a subregion of the field of vision and preferably does not encompass it entirely. In particular, a marginal region of the field of vision can be free of overlap with the partial field. In other words, regions can be specified in the marginal region of the field of vision, that is, the marginal regions in which the sensing data are provided and evaluated by way of the environment sensing device without change from the normal mode. In this way, a kind of tolerance region is specified, for which it cannot be said with certainty, for example, that it is being monitored by the driver looking at it, since it is situated at the edge of the field of vision. This marginal region will therefore still be monitored preferably by way of the environment sensing device, so that the described reduction of the sensing and/or evaluation of the sensing data will only be confined for example to a middle region of the field of vision as the partial field. In this way, uncertainties regarding the determination of the field of vision will be irrelevant to the determination of the partial field, so that the method always determines the partial field actually being monitored by the driver in a reliable manner.

In this regard, another embodiment calls for the size of the non-overlapping marginal region to be set in dependence on the precision of the interior camera. The greater the precision of the interior camera and thus the determination of the field of vision of the driver, the smaller the region specified for the continued sensing and evaluating of the sensing data without a reduction, since in this case it can be assumed that the ascertained field of vision reliably corresponds to the actual field of vision of the driver. However, if the field of vision can only be determined with relatively low accuracy, this will also be taken into account for the size of the marginal region, so that in this case the described reduction will only be performed for a relatively small partial field. This further contributes to the reliable choice of the partial field.

For application cases or situation which may arise during the method and which are not explicitly described here, it can be provided that an error message and/or a request to enter a user feedback will be put out according to the method, and/or a standard setting and/or a predetermined initial state will be established.

A further aspect of the disclosure relates to a motor vehicle. The motor vehicle comprises the at least one environment sensing device. The motor vehicle is adapted to carry out the method described above. The motor vehicle according to the disclosure is preferably designed as an automobile, especially a passenger car or a truck, or as a personal bus or motorcycle.

The disclosure also includes the control device for the motor vehicle. The control device can comprise a data processing device or a processor device which is adapted to carrying out one embodiment of the method according to the disclosure. For this, the processor device can comprise at least one microprocessor and/or at least one microcontroller and/or at least one FPGA (Field Programmable Gate Array) and/or at least one DSP (Digital Signal Processor). Furthermore, the processor device can comprise program code which is adapted to carrying out the embodiment of the method according to the disclosure when executed by the processor device. The program code can be stored in a data storage of the processor device. The processor circuit of the processor device can comprise, e.g., at least one circuit board and/or at least one SoC (System on Chip).

Preferably, the described method is carried out by the control device of the motor vehicle.

The disclosure also includes modifications of the motor vehicle according to the disclosure as well as the control device according to the disclosure having features as were already described in connection with the modifications of the method according to the disclosure. For this reason, the corresponding modifications will not be described here once more.

As a further solution, the disclosure also encompasses a computer-readable storage medium, containing program code which, when executed by a processor circuit of a computer or a cluster of computers, causes them to carry out an embodiment of the method according to the disclosure. The storage medium can be provided, at least partly for example, as a nonvolatile data storage (such as a flash memory and/or as a SSD—solid state drive) and/or at least partially as a volatile data storage (such as a RAM—random access memory). The storage medium can be located in the processor circuit in its data storage. But the storage medium can also be operated for example as a so-called appstore server in the Internet. A processor circuit with at least one microprocessor can be provided by the computer or the computer cluster. The program code can be provided as binary code or Assembler and/or as source code of a programming language (such as C) and/or as program script (such as Python).

The disclosure also encompasses the combinations of the features of the described embodiments. Thus, the disclosure also encompasses realizations having a combination of the features of several of the described embodiments, as long as the embodiments were not described as being mutually exclusive.

### BRIEF DESCRIPTION OF THE SEVERAL VIEWS OF THE DRAWINGS

In the following, exemplary embodiments of the disclosure are described.

FIG. 1 shows a schematic representation of a motor vehicle, in which a field of vision of the driver is indicated; and

FIG. 2 shows in schematic representation, a signal flow chart of a method for operating a motor vehicle having at least one environment sensing device.

### DETAILED DESCRIPTION

The following explained exemplary embodiments are advantageous embodiments of the disclosure. In the exemplary embodiments, the components which are described for the embodiments each constitute individual features of the disclosure, to be considered independently of each other, and which also modify the disclosure independently of each other. Therefore, the disclosure shall also encompass other than the presented combinations of features. Moreover, the described embodiments can also be amplified with other of the already described features of the disclosure.

In the figures, the same reference numbers denote elements of identical function.

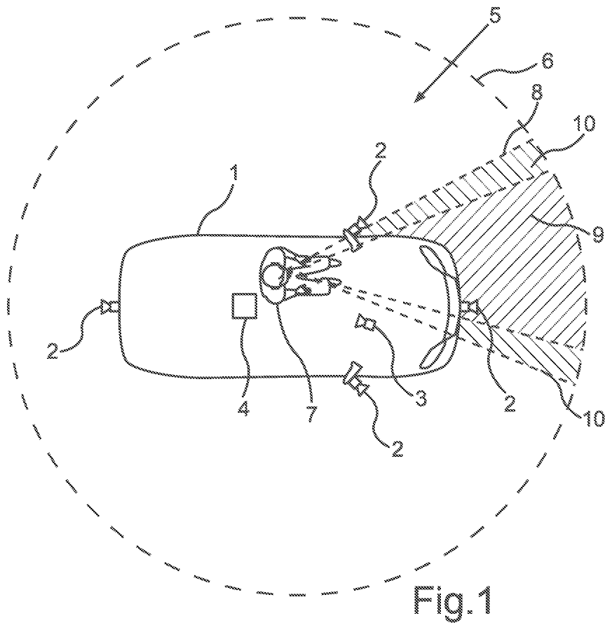

FIG. 1 shows a motor vehicle 1 comprising multiple environment sensing devices 2. These may be, for example, a front camera, a side camera, as well as a rear camera. Moreover, the environment sensing device 2 can be a radar device, a Lidar device, an ultrasound sensor and/or an infrared measurement device. The motor vehicle 1 moreover has an interior camera 3 as well as a control device 4. The control device 4 is a computing device. The environment sensing device 2 is adapted to sense the sensing data which describe an environment 5 of the motor vehicle 1. The environment 5 is preferably bounded by a boundary of the sensing region of the respective environment sensing device 2. The boundary of the sensing region of the environment sensing device 2 is sketched here by a broken line 6.

In the motor vehicle 1 there is located a driver 7, whose view can be detected by way of the interior camera 3. Thus, a field of vision 8 of the driver 7 can be ascertained. Moreover, a partial field 9 of the environment 5 is sketched here, along with two marginal regions 10 of the field of vision 8.

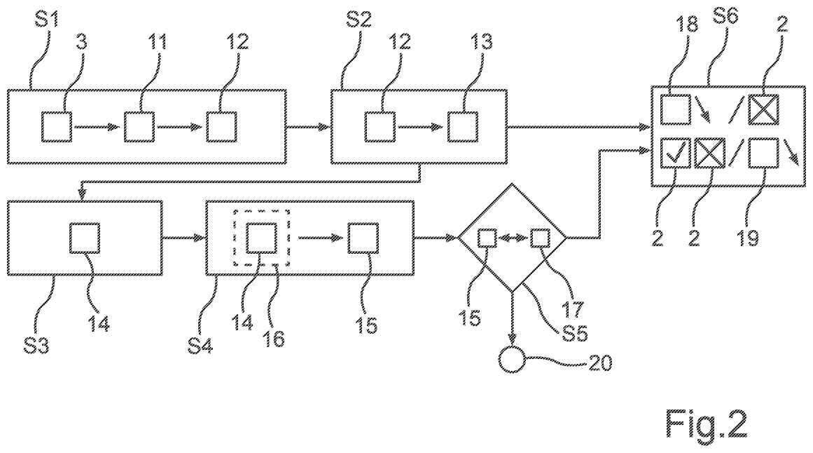

FIG. 2 shows a method for operating the motor vehicle 1 with the at least one environment sensing device 2. In a step S1 of the method, camera data 11 describing the driver 7 and his view can be detected by way of the interior camera 3. In this way, the field of vision data 12 can be determined, describing the field of vision 8 of the driver 7 of the motor vehicle 1. In a step S2, partial field data 13 are determined by evaluating the field of vision data 12 so determined. The partial field data 13 describe the partial field 9 of the environment 5 of the motor vehicle 1 that overlaps with the field of vision 8 of the driver 7. In this example, the partial field 9 may encompass the entire region of the field of vision 8 situated outside the motor vehicle 1 and thus being in the sensing region of the environment sensing device 2.

In a step S3, driver condition data 14 can be determined, which describe a condition of the driver 7. The driver condition data 14 can describe at least one of the following conditions of the driver 7: fatigue, distraction due to operating at least one operating device in the motor vehicle 1, distraction due to an output of at least one output device in the motor vehicle 1, responsiveness to an object in the field of vision 8 and/or a changing of the field of vision 8 due to at least one change of viewing direction. Thus, the present composure of the driver 7 is determined and given a score by way of the driver condition data 14.

In a step S4, attention data 15 can be determined, described the degree of attentiveness with which the driver 7 is looking in the field of vision 8. The attention data 15 are determined by applying an attention detection criterion 16 to the driver condition data 14 so determined. Thus, how attentive the driver 7 is at present is scored ultimately by evaluating the different conditions of the driver.

In a step S5, a check is done to see whether the attention data 15 so determined lie in a given attention value range 17. Only if such is the case will the method proceed to step S6. In step S6, the motor vehicle 1 is operated such that a sensing and/or evaluating of the sensing data which are detected by way of the at least one environment sensing device 2 and which describe the partial field 9 according to the partial field data 13 so determined will be at least reduced. Step

S6 can be done at once after step S2 or only after step S5. In step S6, the reduction of the sensing can involve the reducing of the scan rate 18 of the environment sensing device 2. Alternatively or additionally, the environment sensing device 2 can be deactivated and/or if there are at least two redundant environment sensing devices 2 then one of the at least two environment sensing devices 2 can be deactivated. Upon deactivation of the redundant environment sensing devices 2, at least one of the redundant environment sensing devices 2 always remains activated. Alternatively or additionally, the reduction of the evaluation may involve reducing a portion 19 of the sensing data being evaluated out of the total sensing data detected by way of the environment sensing device 2. Thus, there are different ways possible for carrying out step S6 of the method. The degree of the reduction may be dependent on the attention data 15 so determined. For example, the less attentive the driver 7, the greater the reduction can be.

The partial field 9 according to the partial field data 13 so determined is preferably smaller than the field of vision 8 according to the field of vision data 12 so determined. In particular, one or more marginal regions 10 of the field of vision 8 can be free of overlap with the partial field 9, that is, no reduction of the sensing and/or evaluating of the sensing data can be done in step S6 in these regions. The size of the non-overlapping marginal region 10 can be set in dependence on the precision of the interior camera 3.

It is preferably provided that the reduction of the sensing and/or evaluating of the sensing data for the partial field 9 will be reversed once more as soon as a change occurs in the field of vision 8 and/or as soon as the attention data 15 falls within the attention value range 17, that is, the motor vehicle 1 will once again be operated such that no reduction occurs in the partial field 9. However, the reduction may be done in a new partial field 9, which is at least partially different from the previous partial field 9, where the new partial field 9 is dependent on a new field of vision 8 of the driver 7.

The determining of the field of vision data 12, the partial field data 13, the driver condition data 14 and the attention data 15 and the described operation of the motor vehicle 1 is performed or at least supported preferably by way of the control device 4 of the motor vehicle 1.

If the check performed in step S5 is not successful, the method can be terminated 20.

On the whole, the examples show a system for the resource-sparing use of hardware for driver assist systems. There is proposed a needs-based use of environment sensing devices 2 for the perception of the environment taking into consideration the viewing direction of the driver 7, that is, the field of vision 8. With interior cameras 3 and further interior sensors, the viewing direction or the focus zone of the driver 7 is ascertained and his degree of attentiveness is estimated, that is, the field of vision data 12 and the attention data 15 are determined. If it is ascertained in a driving situation supported by a driver assist system that the driver 7 is focusing his full attentiveness on a portion of the vehicle surroundings, the evaluation of the environment sensing device 2 can be temporarily reduced for this region. That is, the described reduction can occur in the partial field 9. Furthermore, it is conceivable to not only reduce the evaluation of the environment sensing device 2, but also to temporarily restrict the sensor activity. The reduction or restriction can be implemented even to the point of a temporary deactivation.

German patent application no. 102022119772.7, filed Aug. 5, 2022, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for operating a motor vehicle having at least one environment sensing device that senses an environment of the motor vehicle, the method comprising:
determining field of vision data that describe a field of vision of a driver of the motor vehicle;
determining partial field data that describe a partial field of the environment of the motor vehicle overlapping the field of vision of the driver, by evaluating the field of vision data; and
reducing sensing or evaluating of sensing data that are sensed by the at least one environment sensing device and that describe the partial field according to the partial field data.

2. The method according to claim 1, wherein the reducing of the sensing or the evaluating of the sensing data includes reducing a scan rate of the at least one environment sensing device or deactivating the at least one environment sensing device.

3. The method according to claim 2, wherein the at least one environment sensing device includes at least two redundant environment sensing devices, and the reducing of the sensing or the evaluating of the sensing data includes deactivating one of the at least two redundant environment sensing devices.

4. The method according to claim 1, wherein the reducing of the sensing or the evaluating of the sensing data includes reducing a portion of the sensing data that are evaluated out of the sensing data detected by the at least one environment sensing device.

5. The method according to claim 1, further comprising:
determining driver condition data that describe a condition of the driver; and
determining attention data that describe a degree of attentiveness with which the driver is looking in the field of vision by applying an attention detection criterion to the driver condition data,
wherein the reducing of the sensing or the evaluating of the sensing data is performed if the attention data lie in a given attention value range.

6. The method according to claim 5, wherein the driver condition data describe at least one of:
fatigue;
distraction due to operating at least one operating device in the motor vehicle;
distraction due to output of at least one output device in the motor vehicle;
responsiveness to an object in the field of vision; or
changing of the field of vision due to at least one change of viewing direction.

7. The method according to claim 5, wherein a degree of the reducing of the sensing or the evaluating of the sensing data is dependent on the attention data so determined.

8. The method according to claim 1, wherein at least the field of vision data are determined by evaluating camera data of an interior camera of the motor vehicle.

9. The method according to claim 1, wherein the partial field according to the partial field data is smaller than the field of vision according to the field of vision data.

10. The method according to claim 9, wherein a marginal region of the field of vision is free of overlap with the partial field.

11. The method according to claim 10, wherein a size of the marginal region is based on a precision of an interior camera.

12. A motor vehicle comprising:
at least one environment sensing device which, in operation, senses an environment of the motor vehicle; and
a processor coupled to the at least one environment sensing device,
wherein the processor, in operation,
determines field of vision data that describe a field of vision of a driver of the motor vehicle;
determines partial field data that describe a partial field of the environment of the motor vehicle overlapping the field of vision of the driver, by evaluating the field of vision data; and
reduces sensing or evaluating of sensing data that are sensed by the at least one environment sensing device and that describe the partial field according to the partial field data.
